(19) United States
(12) Patent Application Publication
(10) Pub. No.: US 2009/0216511 A1
(43) Pub. Date: Aug. 27, 2009

(54) Sensor Simulator

(75) Inventors: Wolfgang Babel, Weil der Stadt (DE); Detlev Wittmer, Maulbronn (DE)

Correspondence Address: BACON & THOMAS, PLLC, 625 SLATERS LANE, FOURTH FLOOR, ALEXANDRIA, VA, 22314-1176, US

(73) Assignee: ENDRESS + HAUSER CONDUCTA GMBH + CO. KG, Gerlingen (DE)

(21) Appl. No.: 11/991,066

(22) PCT Filed: Jul. 13, 2006
(86) PCT No.: PCT/EP2006/064218

§ 371 Date: Apr. 15, 2009

(30) Foreign Application Priority Data
Aug. 31, 2005 (DE) 10 2005 041 427.3

(51) Int. Cl. G06G 7/62

(52) U.S. Cl. 703/13

(57) ABSTRACT

Sensor simulator for testing behavior of a process installation as a function of signals of a sensor, whose signals are simulated by the sensor simulator, wherein the process installation includes at least one measurement path having a sensor interface for connecting the sensor, to which the sensor simulator can be connected, wherein the simulator includes a measurement path interface, which can be connected to the sensor interface of the measurement path, and outputs signals to the measurement path and/or receives signals from the measurement path; and a control circuit for simulation of signals, which form the output signal of the measurement path interface, wherein the signals include curves of measurement signals as a function of time.

The present invention relates to a test apparatus, especially a sensor simulator, in general for process installations and especially for measurement paths in process installations.

The term “measurement path” refers herein to the route via which a primary sensor signal (a signal dependent on a parameter to be measured) is transmitted to a unit arranged downstream from the sensor, where the sensor signal or a conditioned sensor signal is received, for processing such further or for reacting to such.

Such measurement paths frequently include measurement transmitters, or transmitter modules, connected to a sensor module via suitable interfaces and which condition the primary signal of the sensor module and forward it in another form.

German patent application 100 55 090.8 discloses a plug connector for connecting a sensor module to a measurement transmitter, or to a measurement path, wherein the plug connector includes an interface with galvanically separated transmission of signals and energy from the transmission line to the sensor. The sensor must, in accordance with this goal, be equipped with a minimum quantity of electronic circuitry, in order to be able to modulate, by means of load modulation, the carrier signal transmitted via the interface, for transmitting measurement data. Equally, the transmitter must be capable of using the transmitted data.

Offenlegungsschrift DE 102 18 606.5 of the same applicant discloses a potentiometric sensor, especially a pH-sensor, which has a memory element for storing calibration data, historical data and logistical information. Such data are made available, via a suitable interface, to a transmitter appropriate for the sensor, in order that the transmitter can take these into consideration in evaluating the sensor signal coming from the sensor. The interface can be, in turn, a galvanically separated interface of the above-described kind. Naturally rising with the described, increased functionality of the sensor modules and the transmitter modules is the number of theoretically possible sources of error. The described, expanded possibilities of communication between the interface of the transmitter and the complementary sensor interface provide, however, an approach for checking the functionalities of the transmitter module.

Accordingly, Offenlegungsschrift DE 103 22 278 A1 discloses a simulator for testing a measurement transmitter having a measurement transmitter interface, wherein the sensor simulator includes: A simulator interface, which is connectable to the transmitter interface and outputs signals to the transmitter and/or receives signals from the transmitter; and a control circuit for simulating signals forming the output signal on the simulator interface. The simulator can, additionally, include a signal input which can be connected to a communication output of the transmitter, in order to enable feedback of the transmitter signals. The simulated signals can simulate measured values, state data, or calibration data. The simulator can include a memory module having the functionality of a sensor memory module, wherein the control circuit is suitable for generating signals for initializing read and/or write-commands on the part of the transmitter. The interface of the simulator can include a galvanically separated interface. The simulator can be integrated in a sensor, and the control circuit can, either in periodic intervals or under event control, trigger a test routine by simulation of sensor states.

DE3431076 discloses an arrangement for simulation of a process control, which has a plurality of inputs for measurement parameters. The measurement parameters are either simulated by modified sensors, for example a capacitive, fill-level sensor, on whose measuring tube shaft a metal sleeve is moved different distances, in order to simulate a change in fill level, or by a sensor simulation module, which supplies the different inputs for the measurement parameters. In the simulation, it is checked, whether the process control correctly detects and points-out deviations from desired states and activates adjusters for bringing the simulated actual values to the desired values. This is accomplished, in the case of the described arrangement, by an operator, who must correct the simulated actual values by hand. Even through this system enables testing of the logical structure of a process control, this proposal appears to be unsuited for dynamic situations. Especially the functional reliability of a real process installation in safety- and time-critical situations cannot be checked with this arrangement.

EP0433995 discloses an apparatus for testing a field instrument system. The apparatus includes a test signal generator, which is connected to the signal output line of the instrument, remotely from the instrument, in order to transmit, via the signal output line, test signals to a test signal receiver in the vicinity of the instrument to be tested, wherein the test signal receiver is connected likewise to the signal output line. The test signal receiver controls a sensor simulator, which is connected to a sensor signal input of an instrument to be tested and simulates sensor signals as a function of the test signals and outputs to the sensor signal input. The resulting output signal, which, in the case of correct functioning of the instrument, should be the correct reaction to the simulated sensor signal, is output via the sensor output line of the instrument and fed to the usual receiver in the field instrument system. The receiver can be a display device, a data writer or a controller. In order to close the test circuit logically, an output of the receiver can be fed to a controller, which controls the test signal generator. The apparatus enables therewith the testing of the specified functioning of the field instrument system, for example a fill-level monitoring system, without having to actually vary the fill level. The described apparatus certainly has its justification, but is inflexible to a high degree, since the installation effort for arranging a sensor simulation is relatively large.

A safety-relevant test of functioning of installed process installations or subsystems is only conditionally executable with the above-described simulators and test equipment. This is true, especially, in the case of those installations or subsystems sometimes requiring reconfiguring for fitting different processes.

An object of the present invention is, therefore, to provide a sensor simulator, which overcomes the described disadvantages of the state of the art.

The object is achieved according to the invention by a sensor simulator as defined in the independent patent claim 1.

The invention provides a sensor simulator for testing behavior of a process installation as a function of the signals of a sensor, whose signals are simulated by a sensor simulator, wherein the process installation includes at least one measurement path having a sensor interface for connection of the sensor, to which the sensor simulator is connectable, wherein

the simulator has a measurement path interface, which is connectable to the sensor interface of the measurement path, and outputs signals to the measurement path and/or receives signals from the measurement path; and a control circuit for simulating signals, which form the output signal on the measurement path interface, wherein the signals comprise measurement signals as a function of time.

The sensor interface of the measurement path can be, for example, the interface of a bus coupler, which transmits the sensor signal onto a data bus, for example, a fieldbus, such as a Foundation fieldbus, Profibus, etc., or an interface of a measurement transmitter, which converts the sensor signal and then outputs a measured value in a suitable format, for example 4 . . . 20 mA, or as a fieldbus signal with one of the aforementioned bus protocols. The measurement transmitter can, on occasion, also have a control output, in order to output, besides, or instead of, the measured value output, control signals as a function of the ascertained measured value.

The measurement signals as a function of time can, for example, be calculated in a program, or read out of a data memory of the simulator. Preferably, the simulator includes various test routines varying as a function of time, with the test routines being executable selectively or sequentially by an operator.

The sensor simulator can have a second signal output, via which the just output simulation signals are communicated in parallel to a control unit, which, at the same time, registers the reaction of the process installation to be tested, or the measurement path to be tested, to the simulated sensor signal. Communication of the sensor signals can be done either by parallel transmission of the actual simulation signals, or by transmission of indices and start signals, by which the respective running curves, as a function of time, and their starting points in time, are identified. Transmission can be done, for example, wirelessly, for example by infrared, radio,

GSM, ZigBee, Bluetooth, UMTS, WiFi, or by wire or optical fiber.

In another embodiment of the invention, the sensor simulator includes a synchronized clock, by which the start of the individual curves as a function of time can be accurately detected and identified. In this case, parallel transmission of the signals as a function of time is not required. The functioning of the process installation can then be checked later by comparison of the curves, as a function of time, of signals on the measurement path and, on occasion, of existing control signals of other components of the installation, with the simulated sensor signals at the relevant point in time.

In another embodiment of the invention, the sensor simulator includes a control output for controlling, or starting, at least one dependent slave simulator, which can, for example, be connected to a measuring point in the vicinity of the sensor simulator, which, in this case, can be referred to as the master simulator. Communication between the master simulator and the at least one slave simulator can be wireless, for example by infrared, radio, GSM, ZigBee, Bluetooth, or by wire or optical fiber.

In a further development of the invention, the sensor simulator includes a signal input, via which, for example, a response signal of the process installation, or a component of the process installation, for example a controller, can be fed back. For example, the time behavior of the simulated signal can be varied as a function of the response signal.

An advantage of the simulator of the invention is that a simulation can be performed decentrally in a process installation, in order to monitor the response of the process installation to critical developments of the measurement data as a function of time. For example, this can concern the overheating or over acidification of a reactor, the too rapid emptying of a tank, or a too rapid pressure drop in a process, in the case of which the respective absolute values of the sensor signals are not yet compellingly problematic, wherein a critical situation can, however, be deduced on the basis of the rate of change of the signals.

Use of the simulator of the invention occurs, preferably, in the testing of installations or parts of installations, such as process plants, or parts of process plants.

The sensor simulator can, additionally, include a signal input which receives from a suitable point of the measurement path a signal, for example a 4 . . . 20 mA-signal, of a measurement transmitter, a HART-signal, a Profibus-signal or a Foundation fieldbus signal, in order to check the correctness of the signals communicated from the measurement path, or in order to correlate these signals with the signals generated by the sensor simulator.

The simulated signals can represent, besides measured values, also calibration data, in order, for example, to check correct conversion by a transmitter, and, on the other hand, they can also concern state data, such as, for example, the failure of a component of the sensor. In this case, it must be checked, whether the transmitter is communicating the correct error message, if such is provided.

To the extent that the measuring path for a sensor is designed to include a memory module, the simulator can trigger different reading and writing routines, in order to check the communication between the measurement path and the memory module. This concerns, especially, measurement paths having a transmitter, to which the sensor, or sensor module, is attached as specified.

The interface can comprise, on the one hand, a galvanically separated interface, especially an inductive interface for the transmission of energy to the sensor and for data exchange between sensor and transmitter. Data exchange from transmitter to sensor, or to simulator, occurs, for example, by a transmitter-side modulation of the energy signal, and the data transmission from sensor to transmitter occurs by sensor-side, or sensor-simulator-side, load modulation of the energy signal.

In a further development of the invention, the sensor simulator of the invention is integrated in a sensor, with the control circuit triggering, either at periodic intervals or under event-control, a test routine by a simulation of sensor states.

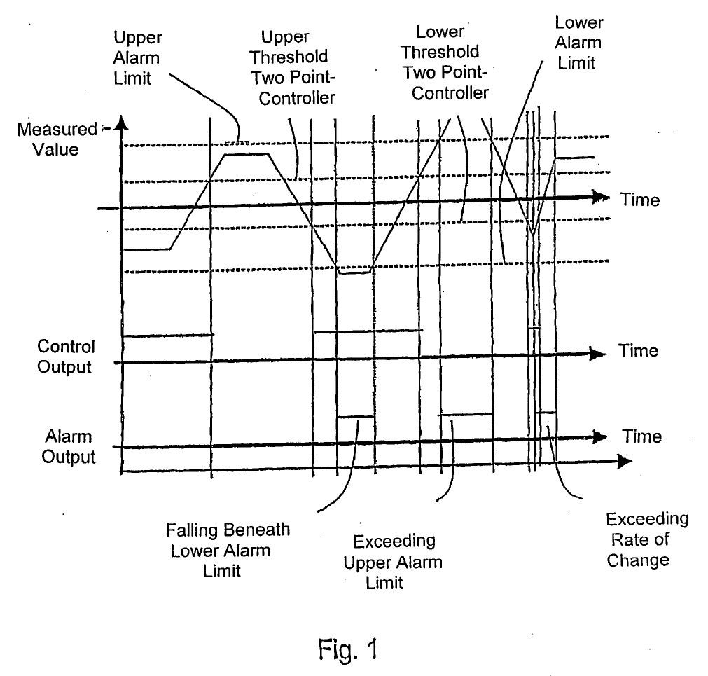

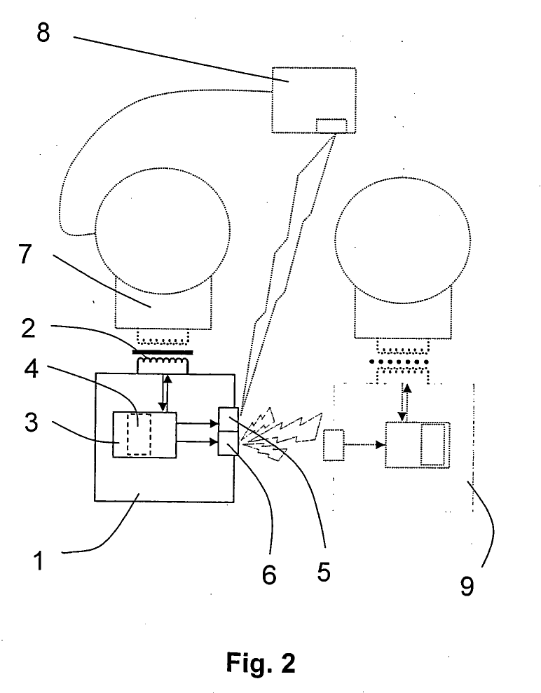

Operation of the simulator of the invention and its use will now be explained on the basis of the waveform diagram in FIG. 1 showing as follows:

FIG. 1 a simulated measured-value curve as a function of time for a pH-sensor, as well as the response of a two-point controller, with an associated alarm output.

The diagram in FIG. 1 shows in its upper portion simulated pH-value as a function of time, as in-coupled via the sensor interface of a measurement path in a process installation. The response signal curve of a two-point controller in the process installation is recorded during testing of the process installation and is shown in the lower portion of the diagram. The two-point controller includes an associated alarm output curve, whose signals are likewise shown.

The two-point controller has an upper threshold and a lower threshold as switching points, with the switching taking place upon crossing of the threshold value in the extreme direction. I.e., the two-point controller switches upon exceeding the upper threshold and upon falling beneath the lower threshold.

Additionally, the controller has an alarm output, which is activated upon exceeding an upper alarm limit and upon falling beneath a lower alarm limit. The alarm output is also activated, when the measured-value is, it is true, still in an uncritical location, but its value is changing too rapidly with time. Also this function of the comptroller, or the functioning of the measurement path up to the controller, can be tested with the simulator of the invention.

### Translation of German Words in the Drawing

FIG. 1:
Change “Messwert” to --Measured value--;
change “Obere Alarmgrenze” to --Upper alarm limit--;
change “obere Schwelle” to --Upper threshold--;
change “Zweipunkt-Regler” (both occurrences) to --Two-point controller--;
change “untere Schwelle” to --Lower threshold--;
change “Untere Alarmgrenze” to --Lower alarm limit--;
change “Zeit” (three occurrences) to --Time--;
change “Überschreitung Änderungssteilheit” to --Exceeding rate of change--;
change “Überschreitung obere Alarmgrenze” to --Exceeding upper alarm limit--; and
change “Unterschreitung untere Alarmgrenze” to --Falling beneath lower alarm limit--

1-18. (canceled)

19. A sensor simulator for the testing behavior of a process installation as a function of signals of a sensor, whose signals are capable of simulation by the sensor simulator, including:
at least one measurement path of the process installation having a sensor interface for connecting a sensor thereto;
a measurement path interface of the sensor simulator, connectable to said sensor interface of the measurement path, said simulator measurement path interface outputs signals to such measurement path and/or receives signals from the measurement path; and
a control circuit for simulation of measured values as a function of time, which form the output signal of the measurement path interface.

20. The sensor simulator as claimed in claim 19, wherein:
said sensor interface of the measurement path includes a bus coupler interface, which transmits sensor signals onto a data bus, for example a fieldbus, such as a Foundation fieldbus, Profibus, or the like.

21. The sensor simulator as claimed in claim 19, wherein:
said sensor interface of the measurement path is a measurement transmitter interface, which converts a sensor signal and then outputs a measured value.

22. The sensor simulator as claimed in claim 19, wherein:
a curve of simulated measurement signals as a function of time is calculated in a program or read out of a data memory of the simulator.

23. The sensor simulator as claimed in claim 19, wherein:
the simulator includes various test routines with different simulated measurement signal curves as a function of time.

24. The sensor simulator as claimed in claim 23, wherein:
the test routines are executable by an operator selectively or sequentially.

25. The sensor simulator as claimed in claim 19, further including:
a second signal output, via which output simulation signals can be communicated in parallel to a control unit.

26. The sensor simulator as claimed in claim 25, wherein:
communication of simulation signals takes place by parallel transmission of actual simulation signals.

27. The sensor simulator as claimed in claim 25, wherein:
communication of simulation signals takes place by transmission of indices and start signals, by which respectively running curves as a function of time and their starting points in time are identified.

28. The sensor simulator as claimed in claim 25, wherein:
said second signal output includes means for transmission by infrared, radio, GSM, ZigBee, Bluetooth.

29. The sensor simulator as claimed in claim 19, further including:
a control output for controlling or starting at least one, dependent slave-simulator, which can be connected, for example, at a measuring point near the sensor simulator.

30. The sensor simulator as claimed in claim 29, wherein:
communication between a master-simulator and said at least one slave-simulator is wireless, for example per infrared, radio, GSM, ZigBee, Bluetooth, UMTS, WiFi, or by wire or optical fiber.

31. The sensor simulator as claimed in claim 19, further including:
additionally, a signal input, via which a response signal of the process installation or a component of the process installation, for example a controller, can be fed back.

32. The sensor simulator as claimed in claim 31, wherein:
a simulated signal curve as a function of time is varied as a function of the response signal.

33. The sensor simulator as claimed in claim 31, wherein:
the signal input is suited for receiving a 4-20 mA signal, a HART-signal, a Profibus signal or a Foundation fieldbus signal, in order to check correctness of signals communicated by the measurement path.

34. The sensor simulator as claimed in claim 19, wherein:
the measurement path interface includes an inductive interface for data exchange with a complementary sensor interface of the measurement path.

35. The sensor simulator as claimed in claim 19, wherein:
energy supply of the sensor simulator takes place via the sensor interface of the measurement path.

36. The sensor simulator as claimed in claim 19, wherein:
the simulator simulates an amperometric sensor, especially a gas sensor, a potentiometric sensor, especially a pH-sensor or a redox sensor, or a sensor for registering another process parameter such as temperature, pressure, fill-level, flow, fill-level, gas, humidity, oxygen content, chlorine content, nitrate content, turbidity, or the like.
